(19) United States
(12) Patent Application Publication
(10) Pub. No.: US 2009/0271087 A1
(43) Pub. Date: Oct. 29, 2009

(54) CONTROL DEVICE AND ENGINE CONTROL DEVICE

(76) Inventor: Yutaka Motonaga, Kobe (JP)

Correspondence Address: OLIFF & BERRIDGE, PLC, P.O. BOX 320850, ALEXANDRIA, VA, 22320-4850, US

(21) Appl. No.: 12/312,776

(22) PCT Filed: Nov. 28, 2007
(86) PCT No.: PCT/JP2007/072959

§ 371 Date: May 27, 2009

(30) Foreign Application Priority Data
Nov. 29, 2006 (JP) 2006-321581

(51) Int. Cl. F02D 45/00

(52) U.S. Cl. 701/102

(57) ABSTRACT

A EFI-ECU 300 that stops an engine when a vehicle has stopped and that starts the engine when an accelerator has been stepped, includes a RAM 304 that stores information from a communication device 301 that acquires information of the outside of the vehicle, and a CPU 302 that determines whether there is need to activate a security device of the vehicle based on information stored in the RAM 304 and that keeps ready condition of the security device if it determines that there is need to activate the security device. Therefore the EFI-ECU 300 enhances the security while the vehicle is stopping.

### BACKGROUND OF THE INVENTION

1. Field of the Invention

The present invention relates to an engine control technology when a vehicle stops.

2. Description of the Related Art

There have been vehicles having an idling stop function stopping an engine in case of the idling stop and accelerator on, to improve mileage and emission. For example, according to Reference 1, an idling stop function estimates a duration stopping an engine based on road information memorized and information on the actual location, and stops an engine automatically when estimated duration seems to be above predetermined time.

Reference 2 discloses a technology monitoring sensors mounted to the vehicle consistently during an engine stop and starting an engine automatically when it determines that the possibility of that the other vehicle collides with the vehicle is high.

[Reference 1] Japanese Unexamined Patent Publication No. 2000-120461

[Reference 2] Japanese Unexamined Patent Publication No. 2006-57456

### SUMMARY OF THE INVENTION

### Problems to be Solved by the Invention

If the vehicle having an idling stop function is rear-ended by other vehicle traveling at high speed, it may jump forward because its anti lock braking system does not work.

In this case, the car jumping forward may collide with obstacles such as a more forward car and a building and induce secondary or more accident.

But even in Reference 2, the case that an activation of a safety device such as an ABS is needed, is not considered.

The present invention has been made in view of the above circumstances, and an object of the present invention is to provide a control device and an engine control device that improve security while a vehicle is stopping.

### Means to Solve the Problems

To achieve this object a control device of this invention that stops an engine when a vehicle has stopped and that starts the engine when an accelerator has been stepped, includes: a memory portion that stores information from a acquire-external-information portion that acquires information of the outside of the vehicle; a control portion that determines whether there is need to activate a security device of the vehicle based on information stored in the memory portion, and keep ready condition to activate the security device if there is need.

With this invention, this control device determines the safeness based on information from the acquire-external-information portion while the vehicle is stopping, and keeps ready condition to activate the security device if it determines that there is a need to activate the security device. Therefore, this control device can improve security while the vehicle is stopping.

An engine control device of this invention is characterized by including: a determine-vehicle-stop portion that determines whether the vehicle has stopped; a determine-activation portion that determines whether there is need to activate a security device of the vehicle if the determine-vehicle-stop portion determines that the vehicle has stopped; a determine-availability-of-stop-engine portion that determines whether to stop an engine or not to stop the engine based on the determination made by the determine-activation portion; a stop-engine portion that stops the engine of the vehicle based on the determination made by the determine-availability-of-stop-engine portion.

With this invention, if the possibility that an accident can happen is high, this engine control system does not take an action to stop the engine. Each device does not stop its function as the engine stops, so drivers can handle the vehicle to the accident without any problems. Therefore, this engine control device realizes more accurate eco-driving function.

In the engine control device above, power supply to the security device of the vehicle is controlled by revolution of the engine.

### EFFECTS OF THE INVENTION

The present invention can provide a control device improving security while a vehicle is stopping.

### BRIEF DESCRIPTION OF THE DRAWINGS

FIG. 1 shows a structure of an embodiment of a control device applied to the EFI-ECU;

FIG. 2 shows an example of a map used for determining whether an engine can be stopped;

FIG. 3 is a flowchart showing first operation of EFI-ECU;

FIG. 4 is a flowchart showing second operation of EFI-ECU;

FIG. 5 shows a structure of a vehicle with the engine control device;

FIG. 6 is a functional block diagram of the engine control unit realized by software control;

FIG. 7 shows a structure of hardware of the engines control device; and

FIG. 8 is a flowchart showing operation of determine-availability-of-stop-engine portion.

### DESCRIPTION OF THE PREFERRED EMBODIMENTS

A description will now be given of embodiments of the present invention with reference to the accompanying drawings.

### First Embodiment

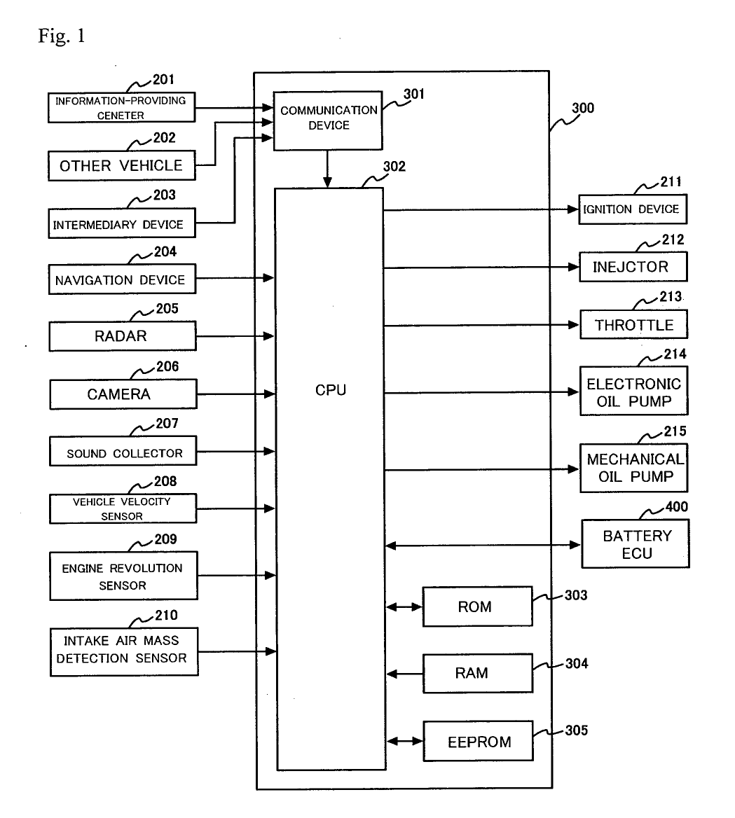

First, a description is given of a structure of this embodiment with reference to FIG. 1. FIG. 1 shows a structure of an EFI-ECU (Electronic Fuel Injection Electronic Control Unit) 300 and its peripheral device.

The EFI-ECU 300 has a communication device 301 as an acquire-external-information portion in the present invention, and acquires information from a information-providing center 201, a intermediary device 203 that relays information provided by the information-providing center 201, and the other vehicle 202 by using radio communication, for example.

The information from the information-providing center 201 includes, for example, traffic information, weather information, electronic mails, city maps, information about shops. The intermediary device 203 stores information from the information-providing center 201 by user's order, and sends this information to the vehicle demanding them.

The communication device 301 of the EFI-ECU 300 acquires information from the information-providing center 201 or an intermediary device 203 by using radio communication, road-to-vehicle communication, and etc.

The communication device 301 communicates with other vehicles (the other vehicle 202) around the vehicle by using vehicle-to-vehicle communication, acquires information such as traffic information from the other vehicle 202, and measures the distance between the other vehicle 202 and the vehicle.

The vehicle has devices such as a navigation device 204, a radar 205, a camera 206, a sound collector 207. The EFI-ECU 300 acquires information from these devices. For example, by using information from the navigation device 204, the EFI-ECU 300 acquires information on an actual location of the vehicle, map information around the vehicle containing the actual location, and so on. The EFI-ECU 300 can measure the distance between the other vehicles 202 around the vehicle and itself by using the radar 205. By using images taken by the camera 206, the EFI-ECU 300 can grasp the traffic congestion condition around the vehicle. By using the sound collected by the sound collector 207, the EFI-ECU 300 can determine whether the distance between the other vehicle 202 and the vehicle is short or long.

Furthermore, the EFI-ECU 300 inputs sensor signals from each sensor such as a vehicle velocity sensor 208, an engine revolution sensor 209, and an intake air mass detection sensor 210, which are located in the vehicle.

The EFI-ECU 300 has a CPU 302, a ROM 303, a RAM 304, and an EEPROM (Electronically Erasable and Programmable ROM) 305 in addition to the communication device 301.

The CPU 302 loads programs stored in the ROM 303, and carries out operations following the program instructions. The procedures carried out by the CPU 303 are described later in a flowchart. The CPU 302 writes outcomes of the operations into The RAM 304 and the EEPROM 305.

The RAM 304 and the EEPROM 305 store information acquired by using a communication tool such as a road-to-vehicle communication, a vehicle-to-vehicle communication, and a radio communication, and store information from the navigation device 204, the radar 205, the camera 206, and the sound collector 207.

The CPU 302 determines ignition timing of the engine and amount of fuel consumption based on the sensor signals of the vehicle velocity sensor 208, the engine revolution sensor 209 and the intake air mass detection sensor 201 and so on. The CPU 302 outputs control signals that controls an ignition device 211, an injector 212, and gate opening of an electronic throttle 213.

The CPU 302 determines whether there is a possibility that the vehicle is rear-ended by the other vehicle by using information stored in the RAM 304 and the EEPROM 305.

The vehicle has an electronic oil pump 214 and a mechanical oil pump 215. These oil pumps 214 and 215 produce the oil pressure to activate hydraulic actuator, and provide lubrication oil in lubricating points of the engine. The vehicle activates an ABS by oil pressure provided by the electronic oil pump 214 or mechanical oil pump 215 during a break, locks tires when needed and stops as avoids tire slip. The vehicle can have the mechanical oil pump 215 only.

In this embodiment, if the vehicle determines that the vehicle is under the circumstances that the vehicle is easily rear-ended while it is stopping, the vehicle keeps ready condition of the safety device such as ABS for example.

The case that the road where the vehicle is running is a highway, an urban way, a national road, or a local road and does not have a traffic jams is listed as the circumstance that the vehicle is easily rear-ended. The case the other vehicle 202 is approaching to the vehicle at high speed is also listed.

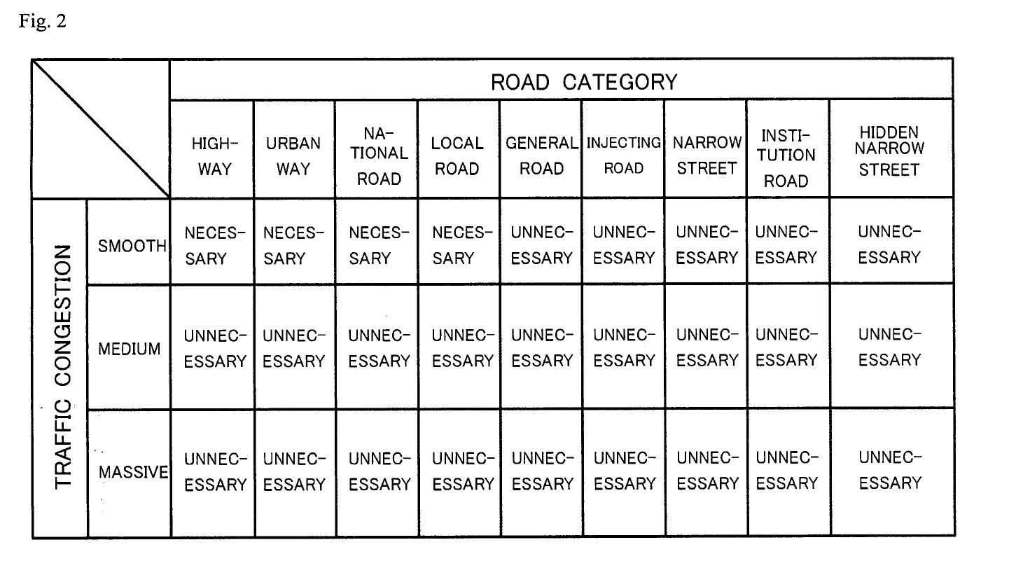

FIG. 2 shows a map showing whether there is need to keep ready condition of the security device based on a road category and traffic state while the vehicle is stopping. This map is stored in memory such as the RAM 304 and the EEPROM 305, and is used by the CPU 302 that determines the need of the security device.

For example, the need to avoidance maneuver against rear-end collision is high on the road such as a highway and a national way where the number of vehicles traveling at high speed is large and the traffic is heavy. The need to avoidance maneuver against rear-end collision is low on the clogged road that the vehicle travels at low speed and a driver needs to drive as seeing to a forward car all the time. On the basis of this way of thinking, data to determine needs for the safety device is defined.

A road-to-vehicle communication with the intermediately device 203, a vehicle-to-vehicle communication with the other vehicle 202, a radio communication, the radar 205, images from the camera 206, the sound collector 207 and etc are used as means to determine the situation of the vehicle. EFI-ECU 300 determines the possibility of rear-end collision by the other vehicle comprehensively based on data from these communication means and devices. EFI-ECU 300 collects data of road circumstances and traffic circumstances around the vehicle, calculates relative distance between the other vehicle and itself, relative velocity to the other vehicle and so on, and determines the possibility of rear-end collision based on these data.

When the EFI-ECU 300 determines that there is the possibility of rear-end collision, it does not stop engine by keep supplying electric power to an ABS function, for example. In the vehicle having the electronic oil pump 214, EFI-ECU 300 activates the electronic oil pump 214. Or, when the electronic oil pump 214 is working, the EFI-ECU 300 does not stop the electronic oil pump 214.

Furthermore, in the vehicle containing the electronic oil pump 213, the EFI-ECU 300 contacts a battery ECU 400 to check whether the battery power is enough to activate the electronic oil pump 214. The EFI-ECU 300 does not stop engine when the battery power is not enough. Meanwhile the EFI-ECU 300 does not stop the electronic oil pump 214 when the battery power is enough.

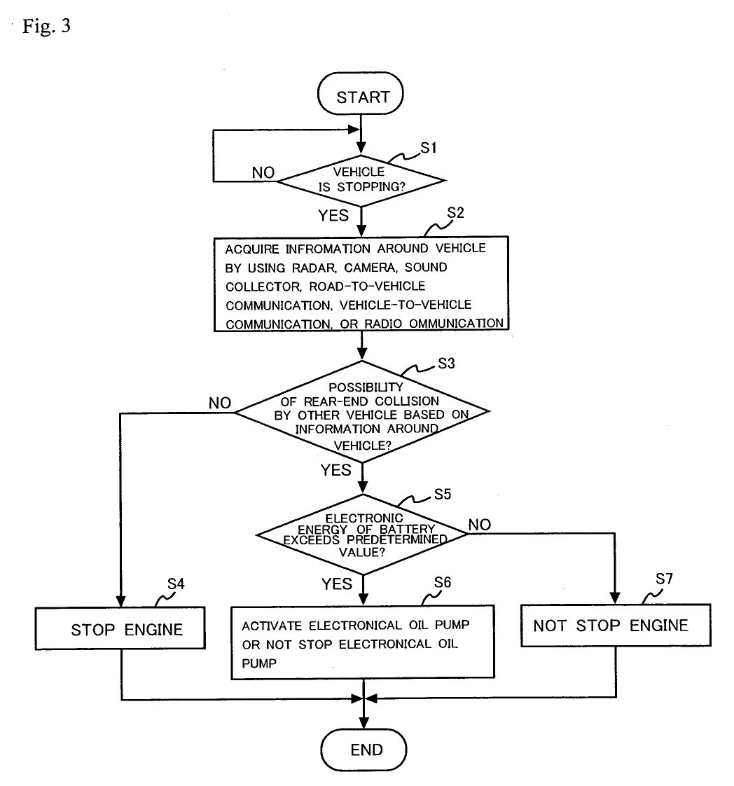

Then, the procedures the EFI-ECU 300 executes are described by a flowchart in FIG. 3. First of all, in the vehicle having the mechanical oil pump 215 and the electronic oil pump 214 the procedure the EFI-ECU 300 executes are described.

The EFI-ECU 300 determines whether the vehicle is stopping (step S1). The EFI-ECU 300 determines whether the vehicle is stopping by using sensor signal from the vehicle velocity sensor 208. If the EFI-ECU 300 determines that the vehicle is not stopping (step S1/NO), the EFI-ECU 300 terminates this procedure.

If the EFI-ECU 300 determines that the vehicle is stopping (step S1/YES), the EFI-ECU 300 collects information around the vehicle by using the radar 205, the sound collector 207, the road-to-vehicle communication, the vehicle-to-vehicle communication or the radio communication (step S2).

Secondly, the EFI-ECU 300 determines whether there is a possibility of rear-end collision by the other vehicle based on the information collected (step S3). The EFI-ECU 300 determines whether there is the possibility of rear-end collision based on the velocity of the vehicle approaching and the distance from the vehicle.

If the EFI-ECU 300 determines that there isn't the possibility of rear-end collision (step S3/NO), the EFI-ECU 300 stops the engine (step S4). If the EFI-ECU 300 determines that there is the possibility of rear-end collision (step S3/YES), the EFI-ECU 300 determines whether electronic energy of the battery exceeds the predetermined value (step S5). The EFI-ECU 300 determines whether electronic energy of the battery acquired from the battery ECU 400 that controls battery charging/discharging condition exceeds the predetermined value (step S5). If the EFI-ECU 300 determines that the electronic energy of the battery exceeds the predetermined value (step S5), the EFI-ECU 300 activates the electronic oil pump 214. If the electronic oil pump 213 is already working, the EFI-ECU 300 does not stop the electronic oil pump 214 (step S6).

If the EFI-ECU 300 determines that the electronic energy of the battery does not exceed the predetermined value (step S5/NO), the EFI-ECU 300 does not stop the engine (step S7).

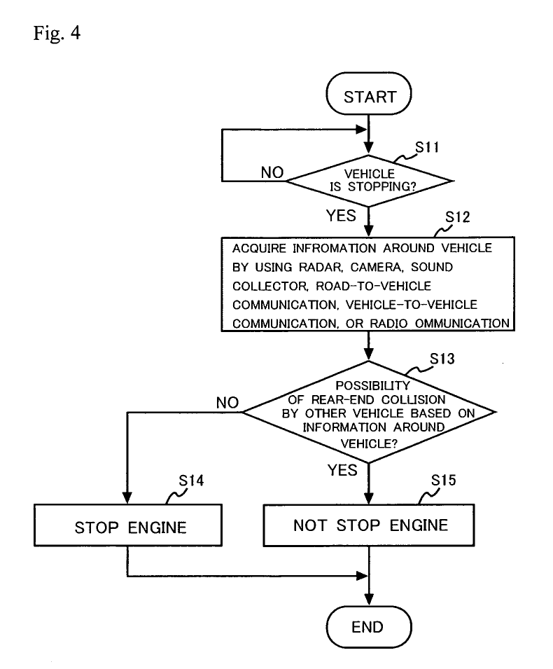

Additionally, in the vehicle having only the mechanical oil pump 215 the procedures the EFI-ECU 300 executes are described by flowchart in FIG. 4.

The procedures of steps S11 thorough S13 to be carried out thereafter are the same as the procedures of steps S1 through S3 shown in FIG. 3.

The EFI-ECU 300 determines whether there is a possibility of rear-end collision based on information collected (step S13). The EFI-ECU300 determines whether there is the possibility of rear-end collision based on the velocity of the vehicle approaching and the distance from the vehicle.

If the EFI-ECU 300 determines that there is not the possibility of rear-end collision (step S13/NO), the EFI-ECU 300 stops the engine (step S14). Meanwhile if the EFI-ECU 300 determines that there is the possibility of rear-end collision (step S13/YES), the EFI-ECU 300 does not stop the engine (step S15).

As described above, in accordance with this embodiment, the EFI-ECU 300 detects the circumstances around the vehicle, the distance between the other vehicles around the vehicle, and the velocity of the other vehicles based on information gotten by a road-to-vehicle communication, a vehicle-to-vehicle communication, a radio communication and etc, and data from a radar, a camera, a sound collector and etc. The EFI-ECU 300 keep the ready condition of the security device by not stopping the engine if the EFI-ECU 300 determines that the possibility that the other vehicle collides with the vehicle is high while the vehicle is stopping. Therefore, the security of the vehicle stopping is improved.

### Second Embodiment

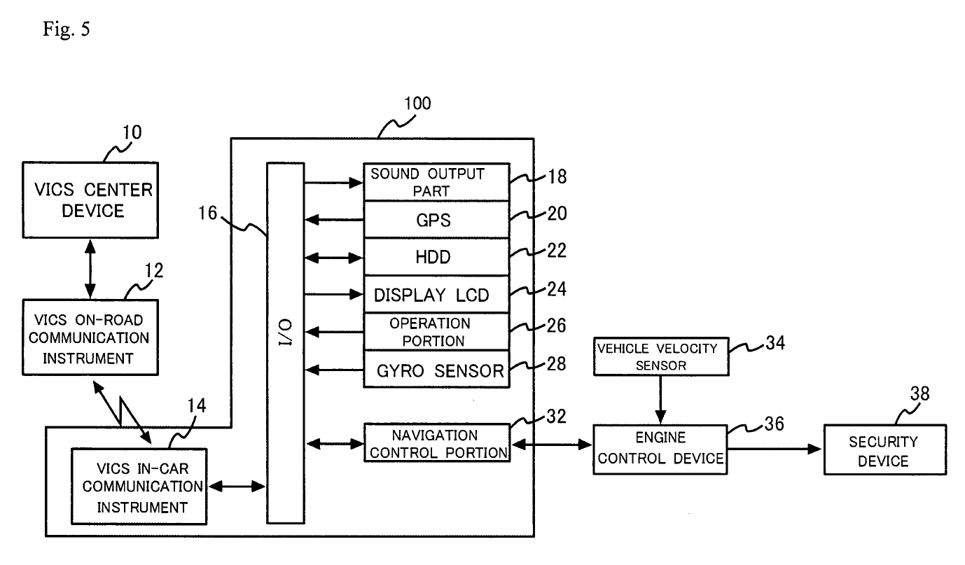

FIG. 5 is a block diagram showing a structure of an engine control device mounted to a vehicle in accordance with this embodiment.

A VICS center device 10 in FIG. 5 is a device to generate traffic information such as traffic congestion information and traffic control to be sent to vehicles based on information acquired from Prefectural police and road administrators. The VICS center contains server computers and is located in a traffic control center.

A VICS on-road communication instrument 12 is a radio communication instrument to provide traffic information generated by the VICS center device 10 to running vehicles. The VICS on-road communication instrument 12 is located on the road and realized by beacons such as a radio wave beacon and an optical beacon that provides traffic information of a highway. The VICS on-road communication instrument 12 can be a device to send multiple broadcasting and broad area traffic information that are one-way data transfer by using FM broadcast from a broadcast station.

Secondly, a car navigation device 100 contains a VICS in-car communication instrument 14, an I/O port 16, a sound output part 18, a GPS 20, a hard disk drive (HDD) 22, a display LCD 24, an operation portion 26, a gyro sensor 28, and a navigation control portion 32. The VICS in-car communication instrument 14 is a receiver located in the car navigation device 100 to receive VICS information, and contains each receiver that receives signals from a radio wave beacon, an optical beacon and FM broadcast station.

The sound output part 18 gives various information to a user by using voice, and contains a voice synthesizer, a voice amplifier, and a speaker. The GPS 20 gets positional information of a running vehicle by using signals from a GPS satellite, and contains a computing unit that analyzes the signal from a GPS satellite. The HDD 20 is the memory device to store map information, road category information, music information and so on, and stores various information in a magnetic disk. The display LCD 24 displays such information as map information stored in the HDD 22 and positional information of the vehicle, and contains a liquid crystal display instrument. In addition, the display LCD 24 can contain a display instrument such as Braun tube or plasma display in place of a liquid crystal display instrument. The operation portion 26 receives operations of a navigation device such as changing scale of displayed map and setting a destination, and contains a touch panel, a send/receive set for a remote controller, and push-button switches. The gyro sensor 28 is a sensor to detect angular velocity of the car navigation device 100, that is sensor to detect angular velocity of the vehicle. The gyro sensor 28 is the sensor to detect Coliolis force with semiconductor by using physical phenomenon that when a vehicle having a velocity rotates, Coriolis force acting perpendicular to direction of velocity is generated. Generally an output pattern of a gyro element is an analog signal, so the gyro sensor 28 converts this analog signal to digital signal by an AD converter. The I/O port 16 acts as an interface between the VICS in-vehicle communication instrument 14, the sound output part 18, the GPS 20, the HDD 22, the display LCD 24, the operation portion 26, the gyro sensor 28 and the navigation control potion 32, and enables signal transmission between these devices. The navigation control portion 32 controls the car navigation device 100 over all based on signals inputted thorough the I/O port 16 and contains a microcomputer. The navigation control portion 32 sends the road category and the traffic congestion information of the road where the vehicle is running to an engine control device 36.

The engine control device 36 controls an engine 106 based on signal of the vehicle speed measured by the vehicle velocity sensor 34, the road category information and traffic congestion information inputted by the navigation control portion 32 and contains a microcomputer.

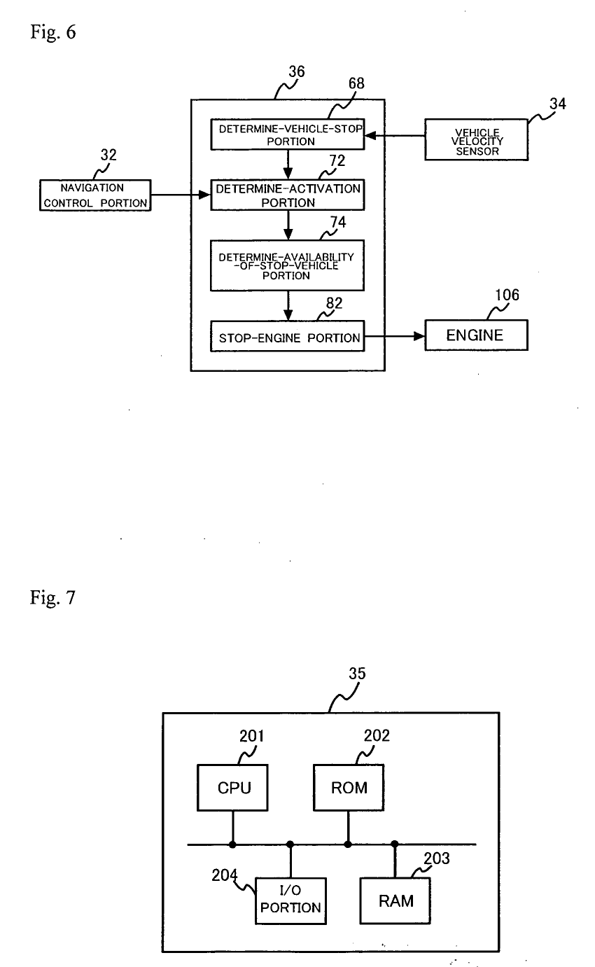

FIG. 6 is a function block diagram showing functions of the engine control device 36 realized by software control. The engine control device 36 also has a CPU 201, a ROM 202, a RAM 203 and an I/O portion 204 as shown in FIG. 7. The CPU 201 loads programs stored in the ROM 202, carries out operations following the program instructions, and realizes each function of a determine-vehicle-stop portion 68, a determine-activation portion 72, an determine-availability-of-stop-engine portion 74 and a stop-engine portion 82 as shown in FIG. 6.

The determine-vehicle-stop portion 68 determines whether the vehicle has stopped based on signal of vehicle speed inputted from the vehicle velocity sensor 34. The vehicle velocity sensor 34 is a sensor such as an optical or a magnetic revolution detection sensor located in output axis of transmission to detect the vehicle speed and outputs pulse signal based on the vehicle speed.

The determine-activation portion 72 acquires the road category information and the traffic congestion information from the navigation control portion 32 and determines circumstances under which the vehicle is running. The determine-activation portion 72 determines whether the road where the vehicle is running is a highway or a national road such as the road where the traffic is heavy and which is being jammed.

The determine-availability-of-stop-engine portion 74 acquires information of circumstances under which the vehicle is running from the determine-vehicle-stop portion 68, and determines whether there is need to activate a security device 38. The security device 38 here means a device that prevents the vehicle from slipping. The determine-availability-of-stop-engine portion 74 acquires the information of circumstances under which the vehicle is running and determines whether the engine can be stopped base on the information acquired. The determine-availability-of-stop-engine portion 74 sends signal representing the determination to the engine stop portion 82.

The stop-engine portion 82 stops the engine 106 based on signal representing the determination of the determine-availability-of-stop-engine portion 74.

The procedures the engine control device 36 executes to realize these functions are described by a flowchart.

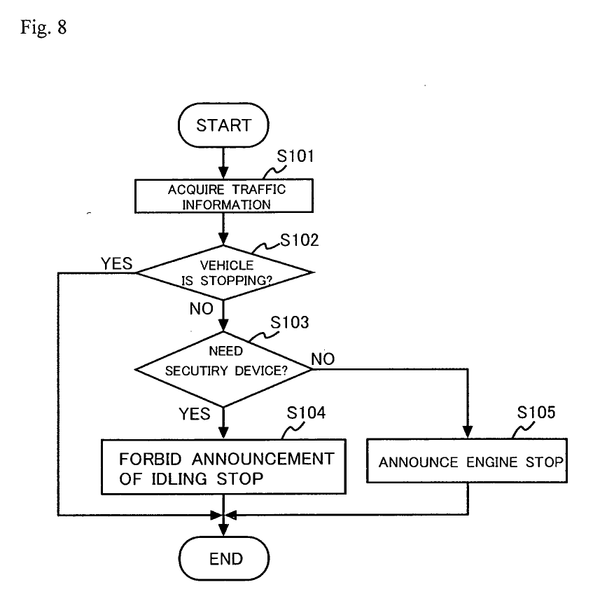

FIG. 8 is a flowchart showing the procedures the engine control device 36 executes. These procedures are repeated while the ignition switch is on. In step S101, the engine control device 36 acquires information of the road where the vehicle is running such as the road category information and the traffic congestion information from the navigation control portion 32, and performs step S102 procedure. In step S102, the engine control device 36 determines whether the vehicle is stopping. If the engine control device 36 determines that the vehicle is stopping, the engine control device 36 performs step S103 procedure. If the engine control device 36 determines that the vehicle is running, the engine control device 36 terminates the procedures. In step S103, the engine control device 36 determines whether the security device is needed based on the road category information acquired in step S101. If the engine control device 36 determines that the security device 38 is needed, the engine control device 36 performs step S104 procedure. If the engine control device 36 determines that the security device 38 is not needed, the engine control device 36 performs step S105 procedure.

The determination in step S103 is made by using the map as shown in FIG. 2. For example, the need to avoidance maneuver against rear-end collision is high on the road such as a highway and a national way where the number of vehicles traveling at high speed is large and the traffic is heavy, and low in the driving clogged road situation that the vehicle travels at low speed and a driver needs to drive seeing to a forward car all the time. On the basis of this way of thinking, data to determine needs for the safety device 38 is defined. In step S104, the engine control device 36 forbids the announcement of the engine stop, and terminates the operation. In step S105, the engine control device 36 announces the recommendation to stop the engine, and terminates the procedure. If the control that stops engine automatically is set, the engine control device 36 stops the engine 106 in step S105.

As described above, in accordance with this embodiment, after the engine control device 36 determines whether there is need to activate the function of the security device working by driving force of engine, the engine control device 36 determines whether the engine can be stopped, and then makes an announcement or controls the engine. Therefore the engine control device 36 can perform engine stop control more properly while the vehicle is stopping.

The above described embodiments are preferred embodiments of the present invention. However, the present invention is not limited to those embodiments, and various changes and modifications may be made to them, without departing from the scope of the invention.

The present invention is based on Japanese Patent Application No. 2006-321581 filed on Nov. 29, 2006, the entire disclosure of which is hereby incorporated by reference.

1. A control device that stops an engine when a vehicle has stopped and that starts the engine when an accelerator has been stepped, comprising:
a memory portion that stores information from an acquire-external-information portion that acquires information of the outside of the vehicle; and
a control portion that determines whether there is need to activate a security device of the vehicle based on information stored in the memory portion, and that keeps ready condition to activate the security device if there is need.

2. An engine control device mounted to a vehicle, comprising:
a determine-vehicle-stop portion that determines whether the vehicle has stopped;
a determine-activation portion that determines whether there is need to activate a security device of the vehicle if the determine-vehicle-stop portion determines that the vehicle has stopped;
a determine-availability-of-stop-engine portion that determines whether to stop an engine or not to stop the engine based on the determination made by the determine-activation portion; and
a stop-engine portion that stops the engine of the vehicle based on the determination made by the determine-availability-of-stop-engine portion.

3. The engine control device as claimed in claim 2, wherein power supply to the security device of the vehicle is controlled by revolution of the engine.
